(19) United States
(12) Patent Application Publication
(10) Pub. No.: US 2021/0352982 A1
(43) Pub. Date: Nov. 18, 2021

(54) FACE MASK AND FACE MASK INSERT

(71) Applicant: Storelli PowerAir, LLC, Dalllas, TX (US)

(72) Inventors: Claudio Storelli, Dallas, TX (US); Thomas Vincent Marchesi, Redding, CT (US)

(21) Appl. No.: 17/225,335

(22) Filed: Apr. 8, 2021

Related U.S. Application Data
(60) Provisional application No. 63/024,420, filed on May 13, 2020.
(60) Provisional application No. 62/706,283, filed on Aug. 7, 2020.

(51) Int. Cl. A41D 13/11; A62B 23/02

(52) U.S. Cl. CPC A41D 13/1161; A62B 23/025

(57) ABSTRACT

An antiviral face mask and a face mask insert that both manage airflow by separating an exhaled breath from an inhaled breath to avoid inhalation of potentially contaminated air and excess carbon dioxide and to filter an exhaled breath to diminish the amount of potentially contaminated carbon dioxide from an exhaled breath into the environment.

### CROSS-REFERENCE TO RELATED APPLICATION

This patent application claims benefit to U.S. Provisional Patent Application No. 62/706,283 filed Aug. 7, 2020 and U.S. Provisional Patent Application No. 63/024,420 filed May 13, 2020, which are hereby incorporated by reference in its entirety as part of the present disclosure.

### FIELD OF THE INVENTION

The present invention relates generally to face masks/face coverings and more specifically, to an antiviral face mask and a face mask insert that both manage airflow by separating an exhaled breath from an inhaled breath to avoid inhalation of potentially contaminated air and excess carbon dioxide and to filter an exhaled breath to diminish the amount of potentially contaminated carbon dioxide from an exhaled breath into the environment. Furthermore, the present invention is directed to an apparatus that is configured to secure the mask to the face of an individual wearing the mask to ensure a tight seal between the mask and the individual's face, including during athletic activities where the mask must be more secure than during normal use (e.g., running, biking, playing soccer, etc.).

### BACKGROUND OF THE INVENTION

Known masks and related apparatuses used for aerobic exercise and athletic activity do not achieve a high level of protection (e.g., multiple layers of synthetic material used in N95 and KN95 masks), do not allow for breathability and do not ensure stability and comfort.

A mask or related device is only effective to preclude potentially contaminated air, particulates and the like from being ingested by an individual that is wearing the mask if the mask blocks all air from passing through or around the mask except through a filter. A major source of unfiltered air that passes around a mask and in turn can be ingested by an individual wearing the mask is through a gap formed between the mask and either side of the nose of the individual wearing the mask. The most ubiquitous and generally effective method to minimize and/or eliminate this gap is for the mask to include a piece of metal that can be bent to the shape of a user's face, specifically over the nose. However, when the mask is tightened the tensioning is actually pulling on this metal piece such that the contoured shape of the metal piece around the individual's nose is deformed, creating a gap on either side of the nose. This is generally acceptable in normal use when less tension is needed, but during a vigorous activity where the mask must be more secure this is a problem. Another problem with this solution is that the mask often slips down to pinch the user's nose in the fleshy area rather than the bone of the skull, and the bridge of the nose. This is uncomfortable, and also restricts the airway of the nose slightly. This is not generally a problem in normal use, but in high aerobic activity this can be detrimental.

Additionally, when a user exhales into a mask that contains a filter, the restricted airflow through a filter limits the amount of air that can move through the material and ultimately to the outside environment before the user starts to inhale. As a result, the user can and commonly does inhale air from the previous breath. This air will have just passed through the lungs and, therefore, will have less oxygen and even more important, contain carbon dioxide, both of which are detrimental to participation in a high aerobic activity during sports. This is typically not an issue during normal activity when the user is not breathing at such a rate as to surpass the air flow rate through the material. When the user is partaking in a high aerobic activity or a sport, this becomes a major issue as the flow rate is surpassed and the exhaled breath does not have time to pass through the mask before the user inhales for the next breath. Additionally, with a traditional mask, oxygen intake can be limited because the mask commonly collapses against the user's face and mouth as the user is attempting to breath in air.

To address this issue, some known masks have incorporated a one-way valve to allow unfiltered exhaled air to pass through the mask and into the environment with no restriction from a filter. This is acceptable when the user is wearing the mask at a distance from others and/or performing an athletic activity away from others. However, when an individual wearing a mask with a one-way valve is in close proximately to others and/or participating in an athletic activity where individuals are in close proximately to each other, especially with elevated breathing, a mask with a one-way valve does not protect others from possibly inhaling an exhaled breath through the one-valve. As such, in many instances, a one-valve is not a solution.

Additionally, in protective masks that include a one-way valve, the valve typically includes a hole that has a diameter of approximately one inch that is sealed by a flexible flap. When enough force (e.g., air pressure from an exhaled breath) contacts the flap, the flap flexes to allow a gap to form and air to pass through the opening of the valve and into the environment. However, because the flap is not flat, it is not able to bend to a fully open state from all sides and thus the actual opening can never be the full diameter of the valve opening (e.g., it cannot be a one inch diameter opening), and when an exhaled breath is not forceful enough (e.g., the user is not breathing heavy enough/the user is not at a high enough aerobic level), the majority of the exhaled air is deflected back toward the face of the user because of the flap will not open or open enough to permit all of the exhaled air to pass through the valve. After a force is no longer applied to the valve, the flap flexes back to a natural state/reseals the valve opening when a force is not applied to the valve to impede air from the external environment that could be contaminated from traveling through the valve and being inhaled by a user of the mask due to air pressure being directed against the flap.

Also, when playing contact sports, a mask must ensure full visibility (i.e., not inhibit the range of vision of the athlete) and also stay in place firmly even if hit (i.e., if dislodged, the mask loses its effectiveness). In addition to the carbon dioxide/breathability issues mentioned above, this invention aims to solve these visibility/stability issues.

### SUMMARY OF THE INVENTION

The present invention is broadly directed to an insert for a face mask/face covering, a face mask itself that is designed to keep the user safe from viral infections and to prevent a user of the mask, which may be infected with a virus from transmitting the virus to others and an apparatus that is configured to secure the mask to the face of an individual wearing the mask to ensure a tight seal between the mask and the individual's face.

The mask and/or insert are configured to separate of an inhaled breath from an exhaled breath of a user. By separating an exhaled and inhaled breath of a user, a buildup of carbon dioxide between the insert and/or mask and face of the user can be avoided.

In an embodiment, the insert includes a frame with an opening on both the left and right side thereof and a ventilation structure that has a plurality of projections, a plurality of flexible fins that are arranged in pairs between the projections and sidewalls that delimit the ventilation structure of the insert apparatus. The frame can comprise a first curved leg defining a base, a second curved leg, spaced from the first leg, defining a top portion of the insert apparatus, a third curved leg, extending between the first and second curved legs, defining a first side of the insert and a fourth curved leg, mirror-opposite the third curved leg, extending between the first and second curved legs, defining a second side of the insert. The projections extend in a first direction beyond a distal end of the fins and a second direction. In the second direction, the projections have a triangular shape with the point of the triangle, when the insert is worn by a user, facing the user's mouth. Air is inhaled through the openings on the right and left side of the insert and exhaled through the ventilation structure. Upon exhaling, the triangular shape of the projections, as opposed to a flat surface which air would be reflected from, aid to direct the expelled into slots created by two adjacent projections and through a gap formed between adjacent fins by the pressure of the expelled breath forcing the fins away from each other. The breath then either enters a cavity formed between a face mask/face covering before being expelled into the environment or the breath is expelled directly into through the mask into the environment, but is prohibited from traveling back through the ventilation structure.

In another embodiment, to achieve the separation of an exhaled and inhaled breath, on inhale, air is forced through a main mesh panel and a first filter that is arranged behind the mesh panel. This air that has been filtered is then inhaled into lungs of a user. When the user exhales, the exhaled breath, which includes carbon dioxide, is directed through a one-way valve that is located directly in front of the user's mouth into a chamber. The exhaled breath is then directed through a second filter and then into the environment. The exhale naturally takes the path of least resistance through the one-way valve as the first filter is configured to permit air to flow in a direction from an exterior of the mask into the mask. The chamber is comprised of very high resistance or non-permeable fabric to avoid reentry of carbon dioxide back into the main cavity formed between the user's face and the mask. To extoll the exhaled breath from the chamber into the environment without dispersing potentially contaminated air into the environment, the chamber has an opening with a filter through which the exhaled air passes into the environment.

As such, the mask of the present invention enables the user to avoid breathing excessive amounts of his/her own exhaled carbon dioxide and thus enabling vigorous athletic activity without the risk of passing out, while also filtering potential harmful viruses from the exhaled air to protect people/athletes around the user.

In an embodiment, the interior of the mask can be divided into three zones: the intake zones on each side and the center exhale zone. The center exhale zone includes a main panel that allows air to flow outward but not inward. The panel can be comprised of horizontal slits in a rigid structure. Flexible material (e.g., latex, or similar material), is fixed to the slits in such a fashion as to allow them to flex outward under pressure from the exhale. When air is inhaled, the flexible material is pinched shut by the pressure.

In an embodiment, the mask can be secured and sealed to the face of a user by a strap securing system. The strap securing system is configured to ensure stability of the mask such that the mask will remain in contact/in place on the face of a user during a vigorous athletic activity including contact sports.

In order to secure and seal the mask of the present invention to the face of a user, the mask can include a main tensioning strap that is fixed at the bridge of the nose of the mask. The strap, which can be comprised of a semi-rigid or elastomeric or material, can be stretched during use to a desired tension and secured to a user via a fastening system (e.g., hook and loop, button, snap, etc.) to a point either on a lower strap or to a point behind the head of a user that is tensioned by the lower strap.

The tensioning strap works to press the bridge piece of the mask toward the user's face. Thus, any shaped foam or plastic piece or bent metal piece that is designed to match the shape of the nose and to fill the gap on either side of the nose is pressed into the face, ensuring a tight fit with no gap. Because this is positioned on the bridge of the nose the air passage is not impeded.

The connection of the tensioning strap can be positioned on either side of the bridge of the nose or directly on it to achieve the same effect. The side of the nose enables the mask to be designed with a minimum of obstruction of the view of the user.

Alternatively, the securing and sealing system of the present invention can include two semi-rigid elements that have some level of spring action and formed in a U-shape and positioned with one end each side of the nose, with the other end ending behind the head, level with the first end. The two ends on either side of the nose and connected with a fabric (or similar) panel. When the two ends of the U-shaped elements behind the head of a user are pulled toward each other, the two ends connected to the strap in front are pulled apart. The strap prevents them from being pulled apart, so the result is the two ends press into the face on either side of the nose. The mask is connected to the U-shaped elements, with the U-shaped elements forming the top boarder of the mask. When the back of these elements are pulled the front ends are in turn pulled into the head, this acts to secure the mask to the head and at the same time to form a tight seal to the face on either side of the nose and cheeks.

In an alternate form, the U-shaped elements end in front of the ears rather than behind the head. In this case they would be smaller versions.

### BRIEF DESCRIPTION OF THE DRAWINGS

FIG. 1 is a side view of a protective mask that includes a secondary chamber to separate inhaled air from exhaled air according to an exemplary embodiment of the present invention;

FIG. 2 is a front view of the mask of FIG. 1;

FIG. 3 is a partial cutaway view of the mask of FIG. 1 showing a one-way valve which allows exhaled air into a secondary chamber and a vent filter according to an exemplary embodiment of the present invention;

FIGS. 4 and 5 are views of a mask that includes a fastening system designed to ensure a secure fit of the mask according to an exemplary embodiment of the present invention;

FIGS. 6-8 are views of a mask depicting an upper securing mechanism that includes rigid elements that attach to the mask and are tensioned to press the mask against the face of an individual to form a seal between the mask and the face of the individual according to exemplary embodiments of the present invention;

FIG. 9 is a front view of a mask that includes a single flexible frame-like element extending between a first end and a second end of the mask according to an exemplary embodiment of the present invention;

FIG. 10 is a front view of a mask that includes two flexible frame-like elements that are spaced from each other and extend between a first end and a second end of the mask according to an exemplary embodiment of the present invention;

FIG. 11 is a side view of a mask that includes a single flexible frame-like element extending at an angle between a first end and a second end of the mask according to an exemplary embodiment of the present invention;

FIG. 12 is a front view of a mask that includes a first flexible frame-like element that extends between a first end and a second end of the mask and a second flexible frame-like element that extends from the first flexible frame-like element according to an exemplary embodiment of the present invention;

FIG. 13 is a side view of a mask that includes a first flexible frame-like element that extends at an angle between a first end and a second end of the mask and a second flexible frame-like element that extends from the first flexible frame-like element according to an exemplary embodiment of the present invention;

FIG. 14 is a side view of a mask that includes two flexible frame-like elements that are spaced from each other and extend between a first end and a second end of the mask according to an exemplary embodiment of the present invention;

FIG. 15 is a side view of a dual chamber mask according to an exemplary embodiment of the present invention;

FIG. 16 is a front view of the mask of FIG. 15 according to an exemplary embodiment of the present invention;

FIG. 17 is a side view of the mask of FIG. 15 being worn by an individual according to an exemplary embodiment of the present invention;

FIGS. 18A-18D are cross-sectional view of the mask of FIG. 15 according to an exemplary embodiment of the present invention;

FIGS. 19A and 19B are perspective views of a frame or shell of the mask of FIG. 15 according to an exemplary embodiment of the present invention;

FIG. 20 is a rear perspective view of a valve of the mask of FIG. 15 according to an exemplary embodiment of the present invention;

FIGS. 21A and 21B are front and rear perspective views, respectively, of the valve of FIG. 20 arranged within the frame of FIGS. 19A and 19B according to an exemplary embodiment of the present invention;

FIG. 22 is a perspective view of a chamber of the mask of FIG. 15 that is configured to encompass the valve of FIG. 20 according to an exemplary embodiment of the present invention;

FIGS. 23 and 24 are a chart that shows the volume of oxygen per minute that can be inhaled by a user according to an exemplary embodiment of the present invention;

FIGS. 25-29A are various views of an insert that is configured to be arranged between a face mask/face covering and the face of an individual according to an exemplary embodiment of the present invention; and

FIGS. 30-34 are various views of another insert that is configured to be arranged between a face mask/face covering and the face of an individual according to an exemplary embodiment of the present invention.

### DETAILED DESCRIPTION OF EMBODIMENTS OF THE INVENTION

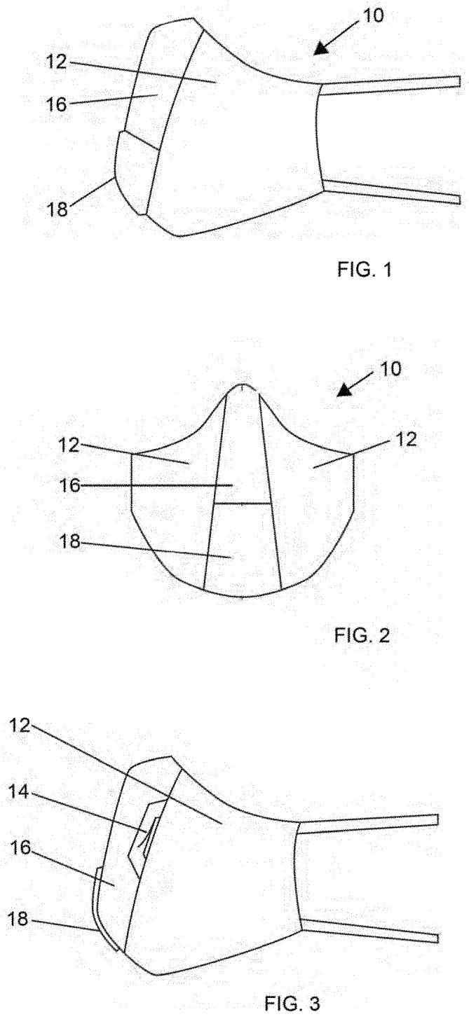

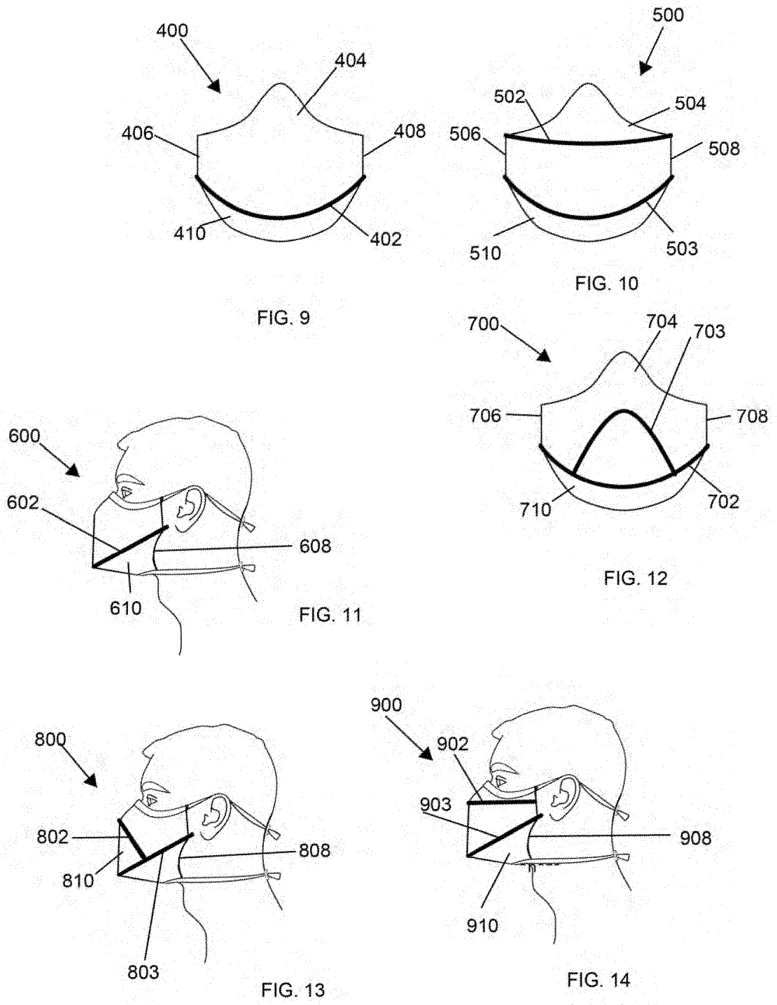

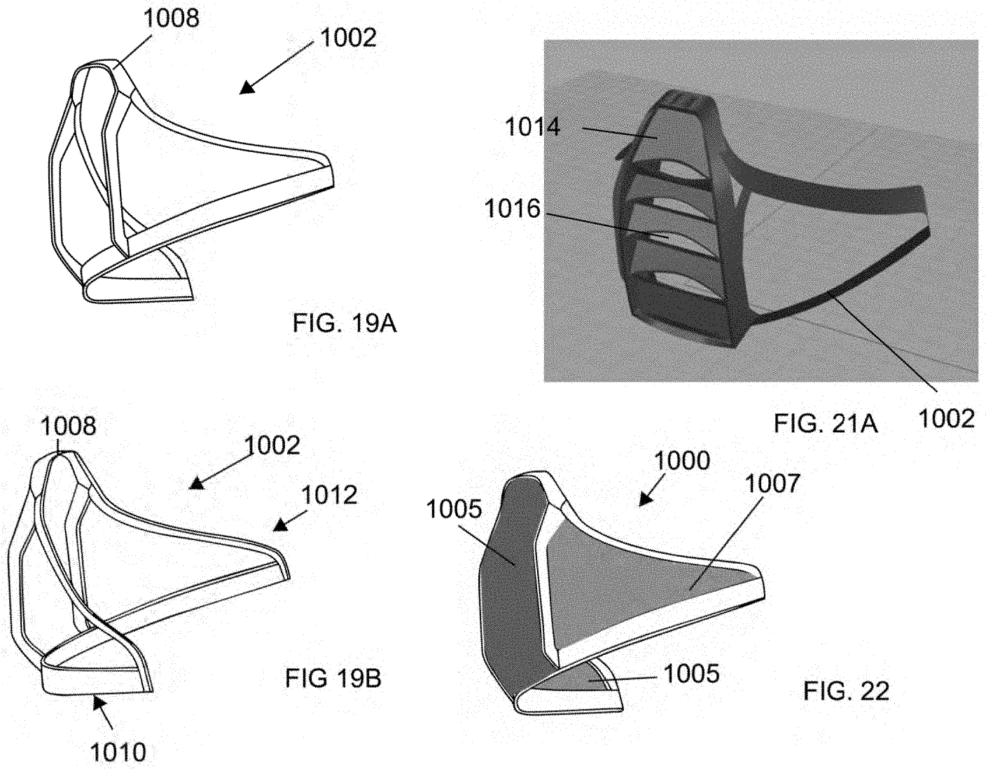

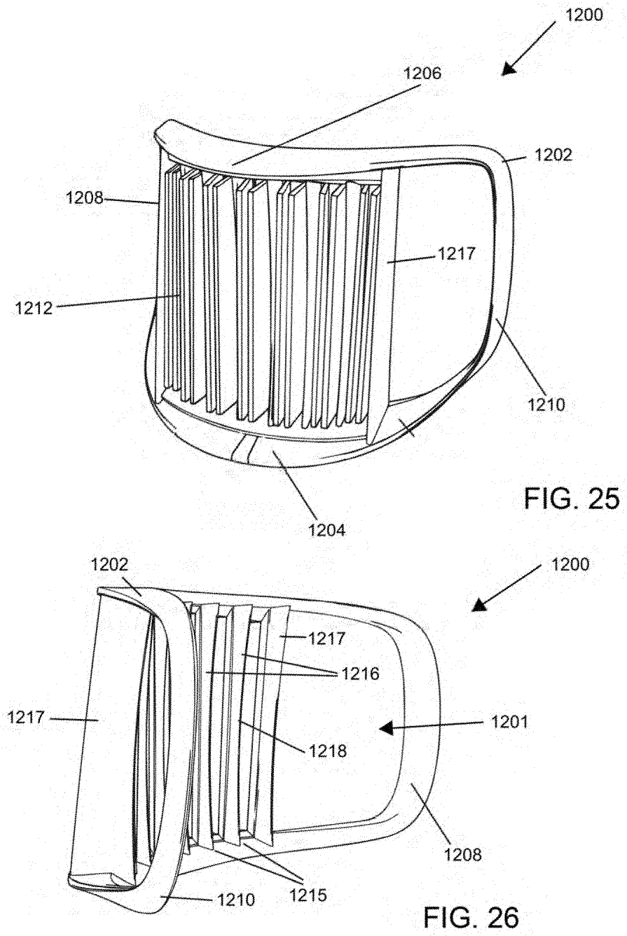

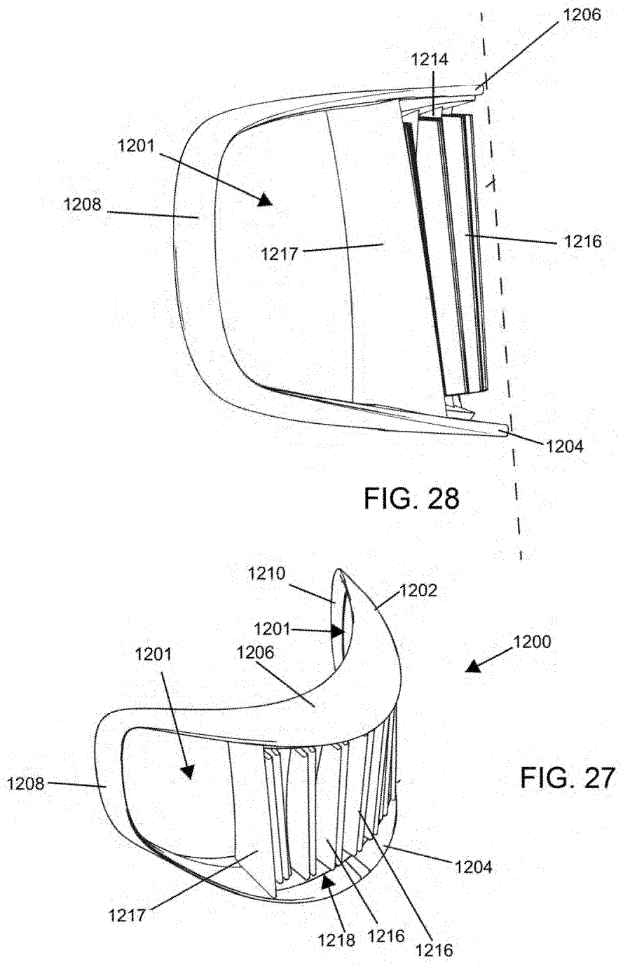

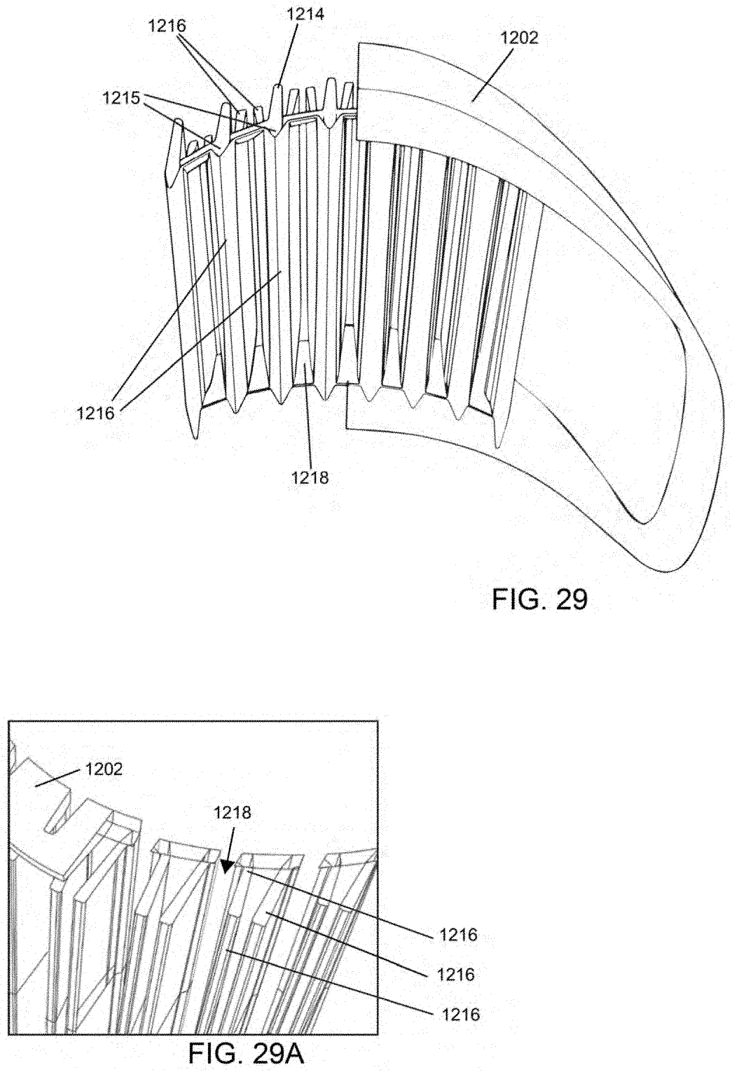

With reference now to the drawings, and in particular FIGS. 1-34, embodiments of protective masks/coverings, associated securing systems thereof and inserts that are configured to be arranged between a protective face mask/covering of the present invention will be described.

FIGS. 1-3 illustrate various views of an embodiment of a protective mask, or covering, 10 that is constructed to be secured against an individual's face to cover the individual's nose and mouth to filter the flow of air breathed in and out to by the individual and to prevent unfiltered exhaled air from being extolled into the environment. While the mask 10 is intended for any human activity from resting to running and contact sports, the mask 10 is designed in particular to preclude the displacement of the mask 10 during an athletic or aerobic activity (e.g., soccer, baseball, basketball, etc.).

The mask 10, which is configured to preclude the individual from breathing in air from the environment that may be contaminated (e.g., with a virus, undesirable particulates, debris, etc.) or a significant percentage of previously exhaled carbon dioxide and exhaling carbon dioxide into the environment, generally includes a first filter 12, a one-way valve 14, a chamber 16 and a second filter 18.

The first filter 12, which is arranged at the right and left aside of the mask 10 (see FIG. 3), is configured to permit air to flow into the mask 10 while prohibiting bodily fluids, carbon dioxide, other particulates, etc. from being inhaled by an individual wearing the mask 10. In order to preclude exhaled carbon dioxide from being substantially inhaled by the individual and in turn make it challenging to participate in an athletic activity with the mask 10 on, the one-way valve 14 (see FIG. 3), which is arranged directly in front of the user's mouth when worn, directs the flow of exhaled air, and in particular carbon dioxide, into the chamber 16. The exhaled air in the chamber 14 then exist the chamber 16 and travels into the environment through the second filter 18 that is configured to filter out the carbon dioxide and any possible particles that may contain be contaminated if the individual is sick. As such, the mask 10 protects the individual wearing it from inhaling potentially contaminated air, inhaling at most trace amounts of exhaled carbon dioxide and prohibits potentially contaminated air exhaled by the individual from entering the environment.

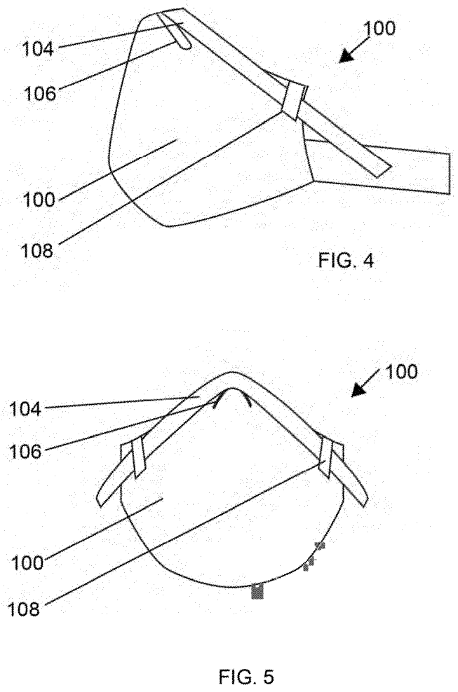

FIGS. 4 and 5 illustrate an embodiment of a mask 100 that includes a fastening system 102 that is configured to tension the mask 100 in place on an individual's face. The fastening system 102 includes a strap 104 that is comprised, for example, of a semi-rigid and/or partially elastomeric material that is connected to the bridge of the nose of the mask 100 by a nose piece 106 and by a securing system 108 from one or both sides of the mask 100. The fastening system 102 ensures a secure fit and tight seal between the mask 100 the face of an individual wearing the mask 100.

The nose piece 106 can be comprised of a strip of metal, plastic, foam, etc. that is deformable to match the contoured shape of the user's nose and in turn fill the gap on either side of the nose in use. Because the nose piece 106 is positioned on the bridge of the nose the air passage of the nose is not impeded. The securing system 108 can be a loop of material through which the strap 104 extends. The fastening system 102 is designed to ensure that the mask 100 will stay securely against the face of an individual and preclude a gap or gaps from forming around the nose of the individual during movement by the individual, which would allow for unfiltered air to enter and exit the mask 100. As depicted in FIG. 4, the strap 104 is not secured to back edge of the mask 100 other than a loop 108 that ensures that the strap 104 does not slip out of position and in turn allow for unfiltered air to be inhaled or exhaled into the environment. To tighten the mask 100 on the face of an individual, the strap 104 is pulled from the bridge of the nose of the mask 100 and not from the back edge of the mask 100 to desired tension and secured to a user via a fastening system (e.g., hook and loop, button, snap, etc.) to a point either on a lower strap 110 or to a point behind the head of a user that is tensioned by the lower strap 110.

The connection of the tensioning strap 104 can be positioned on either side of the bridge of the nose or directly on the bridge of the nose to achieve the same effect. The side of the nose enables the mask 100 to be designed with a minimum of obstruction of the view of the user.

It is noted that the mask 100 can include the features of the mask 10 depicted in FIGS. 1-3 such as filters, a one-way valve and a chamber or it could be devoid of many of these features and only include a filter system.

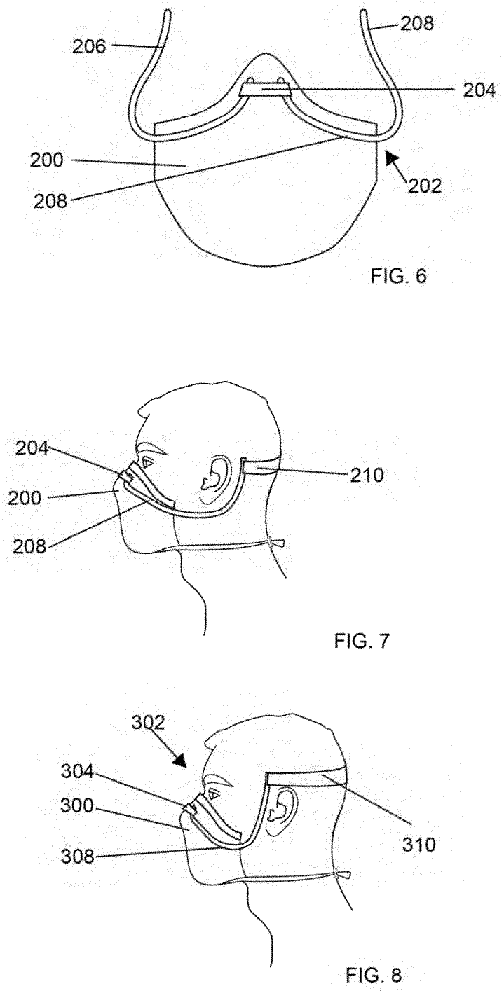

FIG. 6 shows an embodiment of a mask 200 that includes a securing system 202 that is comprised of a connector 204 at the bridge of the nose of the mask 200, a first rigid element 206 and a second rigid element 208. Each of the rigid element 206, 208 include a first end that is fixed on a respective side of the nose of the mask 200 by the connector 204 and each rigid element 206, 208 extends from the first end thereof in a curved manner toward the back of the head of an individual when the mask 200 is in use. The second ends of the rigid elements 206, 208 can be secured to a rear strap 210 to ensure a secure fit of the mask 200 on the face of an individual.

Alternatively, as shown in FIG. 7, a mask 300 can include a securing system 302 that is comprised of a connector 304 at the bridge of the nose of the mask 300, a first rigid element 306 and a second rigid element 308. Each of the rigid element 306, 308 include a first end that is fixed on a respective side of the nose of the mask 300 by the connector 304 and each rigid element 306, 308 extends from the first end thereof in a curved manner below the cheekbones of the individual wearing the mask 300 and then upwardly in at the second end thereof. A back strap 310 secures the rigid elements 306, 308 together behind the head of an individual wearing the mask 300, pulling the rigid elements 306, 308 into the face of the individual wearing the mask 300 and securing the mask 300 to the individual's face and ensuring a tight seal between the mask 300 and face.

In another embodiment the rigid elements 204, 206, 304, 306 do not connect together in the back, but rather curve in such a way as to hook the ears from underneath or above the ears of an individual to secure the mask 200, 300 to the user. In this embodiment there are no straps needed, the connection to the user is solely through the rigid arms 204, 206, 304, 306 that hook the ears, similar to the way some glasses hook the ears, but from below curving up instead of from the top down.

FIG. 7 depicts another embodiment of a mask 400. The mask 400 includes a mask body 402 and a rigid element 404 that extends arcuately about the mask body 402 between a first end 406 and a second end 408 of the mask 400 and material 410 that extends about the mask body 402 to cover at least the mouth and a portion of the nose of an individual. The rigid element 404 is configured to ensure the mask body 402 remains spaced from an individual's face when the mask 400 is being worn and does not collapse inwardly toward the individual's face and in turn prevent the internal cavity that is formed in use between the mask body 402 and the individual's face from limiting air flow for the individual. The rigid element 404 can be comprised of material that is flexible such that as the mask 100 is being secured to the face of an individual, the mask 400 contours to the individual's face. The rigid element 402 aids to keep the mask 400 away from the jaw of a user such that the user can speak without interference by the mask 400.

FIG. 10 depicts an embodiment of a mask 500 that includes a first rigid element 502 and a second rigid element 503 that is spaced from the first rigid element 502. Both rigid elements 502, 503 extend arcuately about a mask body 504 between a first end 506 and the second end 508 of the mask 500 with the material 510 extending about the mask body 504 to cover at least the mouth and a portion of the nose of an individual. The rigid elements 502, 503 can be independent elements. Alternatively, the rigid elements 502, 503 can be aspects of a single element that directly or indirectly connect to each other. The rigid elements 502, 502 aid to keep the mask 500 away from the jaw of a user such that the user can speak without interference by the mask 500.

FIG. 11 depicts a further embodiment of a mask 600 with a single rigid element 602 that extends in a curved manner from an apex at a portion of the mask body 604 that when worn is located near a chin of an individual upwardly toward the ears of an individual and is delimited at a first end 606 and a second end 608 with the material 610 extending about the mask body 604 to cover at least the mouth and a portion of the nose of an individual. The rigid element 602 aids to keep the mask 600 away from the jaw of a user such that the user can speak without interference by the mask 600.

FIG. 12 depicts an embodiment of a mask 700 with a first rigid element 702 that extends at a lower region of the mask 700 in a curved manner between the first end 706 and the second end 708 of the mask body 704 and a second rigid element 703 that extends from the first rigid element 702 with the material 710 extending about the mask body 704 to cover at least the mouth and a portion of the nose of an individual. At least the first rigid element 702 aids to keep the mask 700 away from the jaw of a user such that the user can speak without interference by the mask 700.

FIG. 13 depicts a further embodiment of a mask 800 with a first rigid element 802 that extends in a curved manner from an apex at a portion of the mask body 804 that when worn is located near a chin of an individual upwardly toward the individual's ears and is delimited at a first end 806 and a second end 808 and a second rigid element 803 that extends from the first rigid element 802. Material 810 extending about the mask body 804 to cover at least the mouth and a portion of the nose of an individual. At least the first rigid element 802 aids to keep the mask 800 away from the jaw of a user such that the user can speak without interference by the mask 800.

FIG. 14 depicts another embodiment of a mask 900 with a first rigid element 902 that extends in a curved manner from an apex at a portion of the mask body 904 that when worn is located near a chin of an individual upwardly toward the individual's ears and is delimited at a first end 906 and a second end 908 and a second rigid element 903 that is spaced from the first rigid element 902 and extends from the first rigid element 902. Material 910 extending about the mask body 904 to cover at least the mouth and a portion of the nose of an individual. The rigid element 902, 903 aid to keep the mask 900 away from the jaw of a user such that the user can speak without interference by the mask 900.

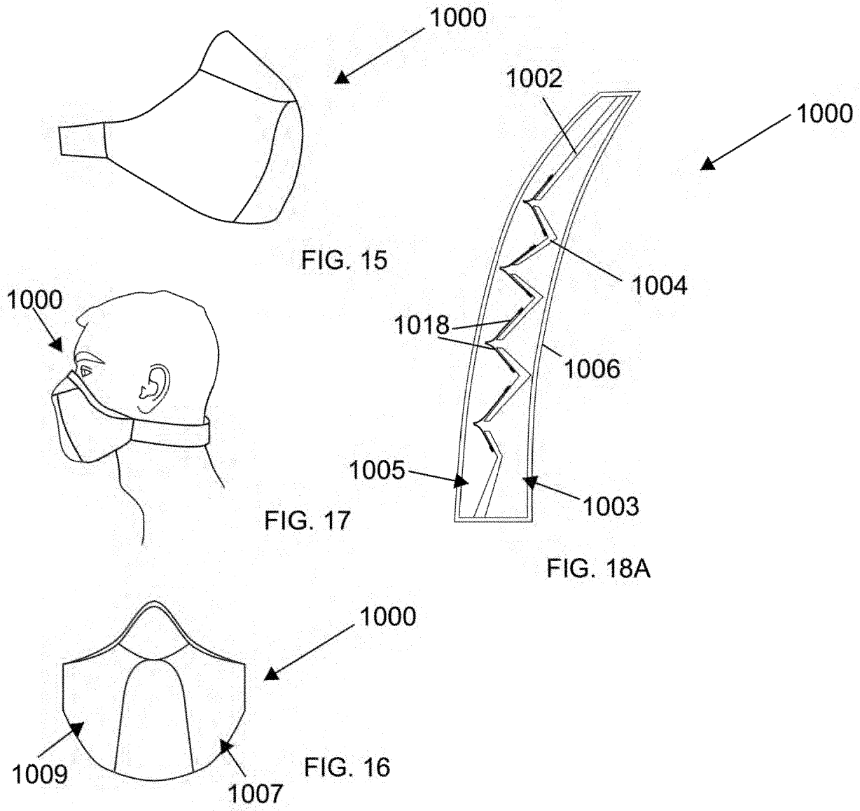

FIGS. 15-22 illustrate various views of another embodiment of a protective mask 1000 that is constructed to be secured against an individual's face to cover the individual's nose and mouth to filter the flow of air breathed in and out to by the individual and to prevent unfiltered exhaled air from being extolled into the environment. While the mask 1000 is intended for any human activity from resting to running and contact sports, the mask 1000 is designed in particular for use during an aerobic and/or athletic activity (e.g., soccer, baseball, football, running, basketball, etc.).

The mask 1000, which is configured to preclude the individual from breathing in air from the environment that may be contaminated (e.g., with a virus, undesirable particulates, debris, etc.) or a significant percentage of previously exhaled carbon dioxide and exhaling carbon dioxide into the environment, generally includes a frame or shell 1002, a valve 1004 and a layer of material 1006 of N95 quality (e.g., multiple layers of synthetic material) or higher encompassing the shell 1002 and valve 1004 and forming a first chamber 1003 and a second chamber 1005 between the material 1006 and the frame 1002/valve 1004. The layer of material 1006 is a filter that screens air inhaled and exhaled for the safety of the individual wearing the mask and to prevent intake and/or extolling of contaminated and/or harmful air.

The interior of the mask 1000 can be divided into three zones (1) a first intake zone 1007, (2) a second intake zone 1009 and (3) an exhale zone (center of mask) 1011.

The frame 1002 is designed to maximize an inhale surface area by creating the first chamber or inner volume 1003 between the mask 1000 and the mouth of an individual wearing the mask 1000 in use. The frame 1002 includes a nose piece 1008 that is configured to be arranged to contact the bridge of the nose of an individual wearing the mask and a first side 1010 and a second side 1012 that are configured to extend rearwardly about each side of the individual's face in use. The frame 1002 is comprised of a material that prevents the collapse thereof on an individual's face during use and as such ensures that there is no obstruction to air flow for the individual or speech by the individual.

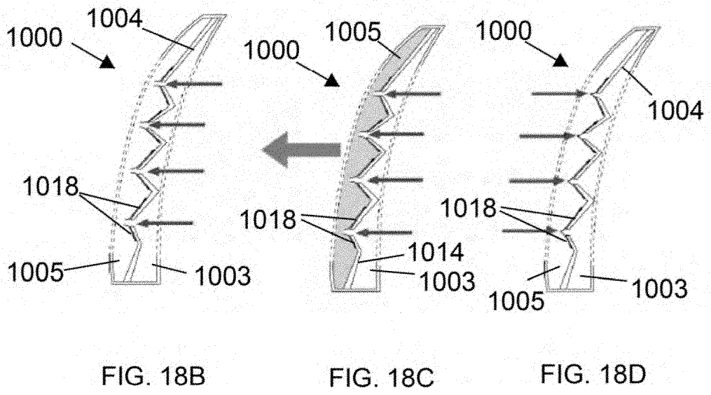

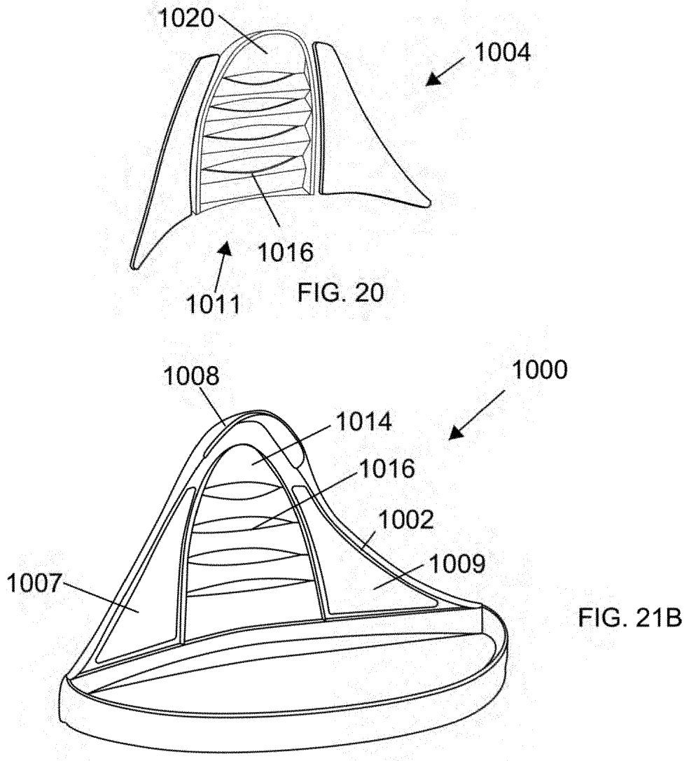

FIG. 20 illustrate an embodiment of the valve 1004. The valve 1004, which can be molded or 3D printed, includes a rigid main panel 1014 that has a plurality of horizontal openings or slits 1016 that are configured to direct air to flow outward and not inward. For example, the openings 1016 can be configured to resemble to some extent venetian blinds. While the embodiments depicted herein show a plurality of openings 1016, there can be as few as a single opening 1016 and/or the opening(s) 1016 can extend horizontally, vertically or any other arrangement that may be known or become known. Two pieces of flexible material (e.g., latex) or wings 1018 (See FIG. 18A-18D) are fixed to opposite sides of the slits or openings 1016. The pieces of material 1016 are configured to meet at an angle to seal the openings 1016 in a resting state and flex outwardly under pressure during an exhaled breath. When air is not being exhaled and being inhaled, the flexible material 1018 that is fixed to the slits 1016 flexes or is pressed together to seal the valve 1004. Alternatively, a single piece of material can be fixed to each opening or slit 1016 that is sealed by pressing against the main body 1020 of the valve 1004.

FIGS. 18B-18C depict the valve 1004. As can be seen in FIG. 18B, when a user exhales a breath, a force/pressure from the breath is applied to the valve 1004 and the force/pressure of the breath overcomes the sealing properties of the flexible material 1018 forcing the material 1018 to flex and create and opening through which the exhaled breath can be directed. As shown in FIG. 18C, once the exhaled breath passes through the valve 1004, it enters the second chamber 1005, is prevented by the valve 1004 from reentering the first chamber 1003 and/or be inhaled again by a user and is extolled into the environment through the filter 1006 which prohibits potentially harmful particles from entering into the environment. The pressure of multiple exhaled breaths through the valve 1004 and second chamber 1005 aids in forcing the air through the material/filter 1006. By spacing the filter 1006 from the face of a user, a large force is not required for air to pass through the filter making the mask 1000 ideal for activities that may result in heavy breathing.

FIGS. 16 and 18D in combination show how a breath can be inhaled through the mask 1000 by a user. Upon an inhaled breath, air travels through the first and second intake zones 1007 and 1009 where the air being inhaled passes through the filter 1006 both on the front of the mask 1000 and the rear of the mask 1000 to ensure clean air is being inhaled by a user. The valve 1004 is sealed by the flexible material 1018 such that the inhaled air cannot travel through the valve 1004 and only air that has been exhaled in use can travel through the valve 1004.

FIGS. 21A and 21B depict the valve 1004 arranged within the frame 1002.

FIG. 22 depicts the second chamber 1005 that extends between the valve 1004 and the frame 1002 and the filter 1006 as well as the first and second intake zones 1007 and 1009.

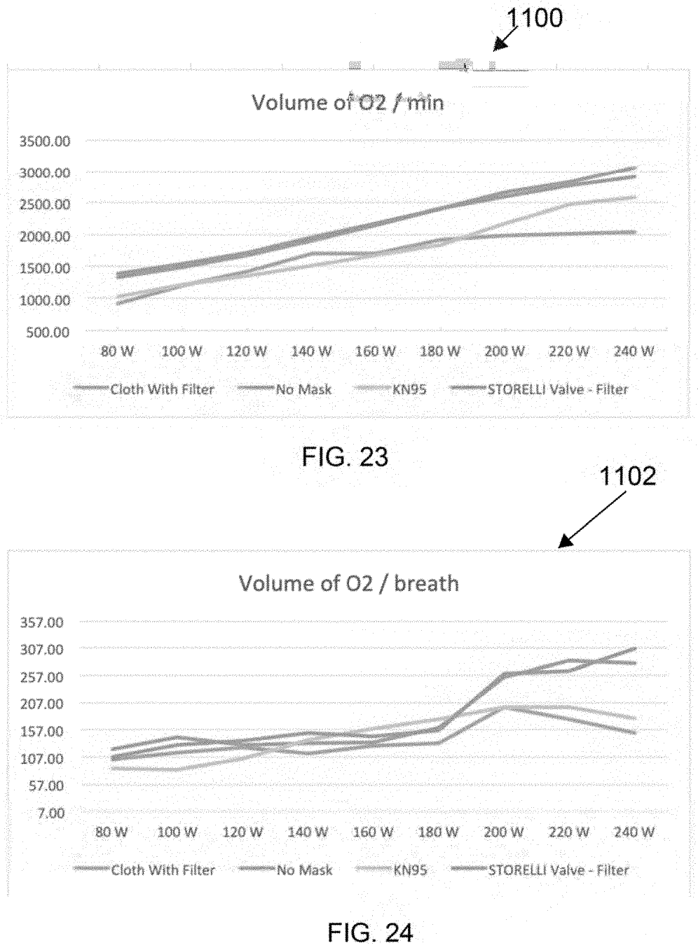

FIGS. 23 and 24 are graphs 1100 and 1102, respectively, that compares performance of the mask 1000 with no mask and other face coverings. As shown in the graphs 1100 and 1102, the mask 1000 has a breathability profile that closely resembles not wearing a mask.

FIGS. 25-29A depict various views of a power air insert 1200 that is configured to be arranged between a face mask/face covering and the face of an individual wearing a face mask/face covering or incorporated into a face mask/face covering.

The insert 1200, which can be comprised of a single unitary structure, includes a frame 1202 that is generally comprised of a first curved leg 1204 defining a base, a second curved leg 1206, spaced from the first leg 1204, defining a top portion of the insert apparatus 1200, a third curved leg 1208, extending between the first and second curved legs 1204, 1206, defining a first side of the insert 1200, a fourth curved leg 1210 mirror-opposite the third curved leg 1208, extending between the first and second curved legs 1204, 1206, defining a second side of the insert 1200 and a venting mechanism 1212.

The insert 1200 is configured to be placed in front of the mouth of a user with the first and second curved arms 1206, 1208 adaptable to rest against the cheeks of the user. The tension of the face mask/face covering keeps the insert 1200 in place. The user can speak and breath normally because the insert 1200 prevents the mask/covering from contacting the user's mouth and in turn prevents changes in speaking mechanics by the user.

The ventilation mechanism 1212 as shown in the figures extends between the first leg 1204 and the second leg 1206 of the frame 1202. However, the ventilation mechanism 1212 can, alternatively, extend between the third leg 1208 and the fourth leg 1210 of the frame 1202.

The ventilation mechanism 1212 includes a plurality of projections 1214, a plurality of fins 1216 that are arranged in pairs between the projections 1214 and sidewalls 1217 that delimit the power air insert apparatus 1212. The projections 1214 extend in a first direction between the fins 1216 and in a second direction. In the second direction, the projections have a triangular shape 1215 with the point of the triangle, when the insert 1200 is worn by a user, facing the user's mouth. The triangular shape 1215 of the projections 1214, as opposed to a flat surface which air would be reflected from, aids to direct air expelled by the user into vents or slots 1218 created by two adjacent projections 1214 and either into a cavity formed between the exterior of the insert 1212 and interior of a face mask/face covering or directly into the face mask/face covering and into the environment.

The fins 1216, which can be comprised of for example, silicone rubber, TPU, TPE, and the like, can extend toward each other such that when an exhaled breath is directed by the protections 1214 toward the fins 1216, the exhaled air is compressed and the fins 1216, which each have a living hinge incorporated therein to assist in allowing it to flex and create a space therebetween due to a buildup of pressure on the fins 1216. After air from an exhaled breath is forced between the fins 1216, the fins 1216 return to a resting position in which the fins 1216 can contact each other at a distal end of each fin 1216 to prevent the exhaled air from reentering the space between the insert 1200 and a user's mouth or can have a slight space therebetween to allow even the slightest breath to be expelled.

Air can be inhaled only through openings 1201 in the sides of the frame 1202. As such, upon an inhaled breath, the fins 1216, flex closed due to external forces forcing air to only be received through the openings 1201 in the sides of the frame 1202.

The fins 1216 are distinguishable from a traditional valve because a typical valve found in face masks because typical valves are comprised of a soft material that bends open to allow air to escape, its natural position to be flat against a rigid structure that allows it to form the seal. Because this valve is round, it has no specific bend line or zone, but rather relies on the flexibly of the material.

The secondary chamber references above can, for example, be formed by the insert 1200 and a mask because the first and second legs 1204, 1206 of the frame 1202 as shown in FIG. 28 extend beyond the fins 1216 to create a cavity between the insert 1200 and a mask. The sidewalls 1217 prevent the expelled air from being re-inhaled by a user.

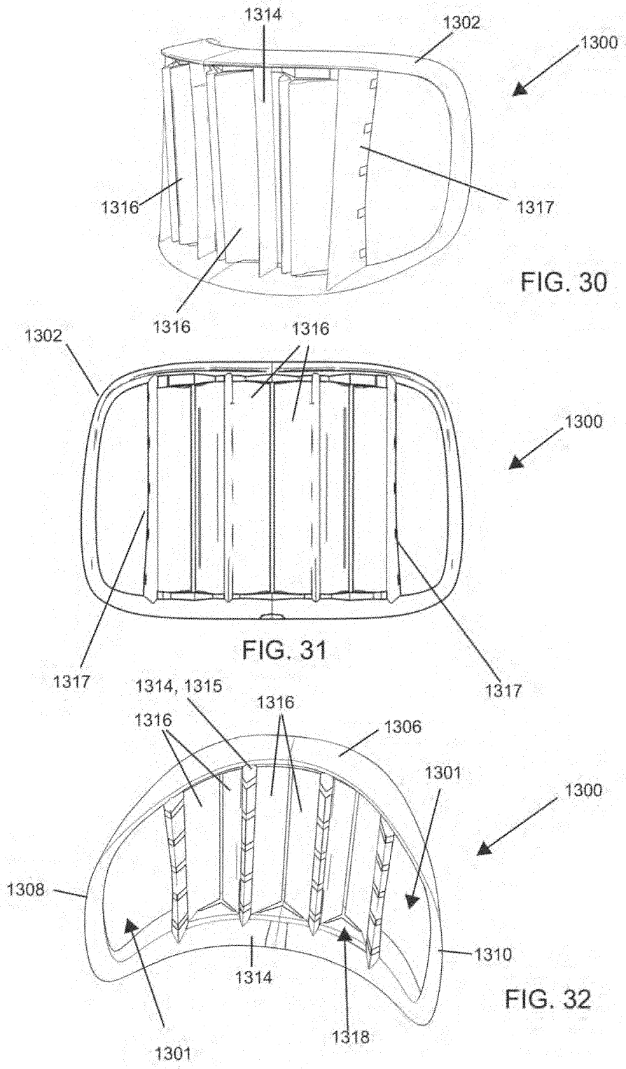

FIGS. 30-34 depict another power air insert 1300 that is configured to be arranged between a face mask/face covering and the face of an individual wearing a face mask/face covering or incorporated into a face mask/face covering. The difference between the insert 1200 and the insert 1300 being there are less fins included in the insert 1300 than in the insert 1200.

The insert 1300, which can be comprised of a single unitary structure, includes a frame 1302 that is generally comprised of a first curved leg 1304 defining a base, a second curved leg 1306, spaced from the first leg 1304, defining a top portion of the insert apparatus 1300, a third curved leg 1308, extending between the first and second curved legs 1304, 1306, defining a first side of the insert 1300, a fourth curved leg 1310 mirror-opposite the third curved leg 1308, extending between the first and second curved legs 1304, 1306, defining a second side of the insert 1300 and a venting mechanism 1312.

The insert 1300 is configured to be placed in front of the mouth of a user with the first and second curved arms 1306, 1308 adaptable to rest against the cheeks of the user. The tension of the face mask/face covering keeps the insert 1300 in place. The user can speak and breath normally because the insert 1300 prevents the mask/covering from contacting the user's mouth and in turn prevents changes in speaking mechanics by the user.

The ventilation mechanism 1312 as shown in the figures extends between the first leg 1304 and the second leg 1206 of the frame 1302. However, the ventilation mechanism 1312 can, alternatively, extend between the third leg 1308 and the fourth leg 1310 of the frame 1302.

The ventilation mechanism 1312 includes a plurality of projections 1214, a plurality of fins 1316 that are arranged in pairs between the projections 1314 and sidewalls 1317 that delimit the power air insert apparatus 1312. The projections 1314 extend in a first direction between the fins 1316 and in a second direction. In the second direction, the projections have a triangular shape 1315 with the point of the triangle, when the insert 1300 is worn by a user, facing the user's mouth. The triangular shape 1315 of the projections 1314, as opposed to a flat surface which air would be reflected from, aids to direct air expelled by the user into vents or slots 1318 created by two adjacent projections 1314 and either into a cavity formed between the exterior of the insert 1312 and interior of a face mask/face covering or directly into the face mask/face covering and into the environment.

The fins 1316, which can be comprised of for example, silicone rubber, TPU, TPE, and the like, can extend toward each other such that when an exhaled breath is directed by the protections 1314 toward the fins 1316, the exhaled air is compressed and the fins 1316, which each have a living hinge incorporated therein to assist in allowing it to flex and create a space therebetween due to a buildup of pressure on the fins 1316. After air from an exhaled breath is forced between the fins 1316, the fins 1316 return to a resting position in which the fins 1316 can contact each other at a distal end of each fin 1316 to prevent the exhaled air from reentering the space between the insert 1300 and a user's mouth or can have a slight space therebetween to allow even the slightest breath to be expelled.

Air can be inhaled only through openings 1301 in the sides of the frame 1302. As such, upon an inhaled breath, the fins 1316, flex closed due to external forces forcing air to only be received through the openings 1301 in the sides of the frame 1302.

The fins 1316 are distinguishable from a traditional valve because a typical valve found in face masks because typical valves are comprised of a soft material that bends open to allow air to escape, its natural position to be flat against a rigid structure that allows it to form the seal. Because this valve is round, it has no specific bend line or zone, but rather relies on the flexibly of the material.

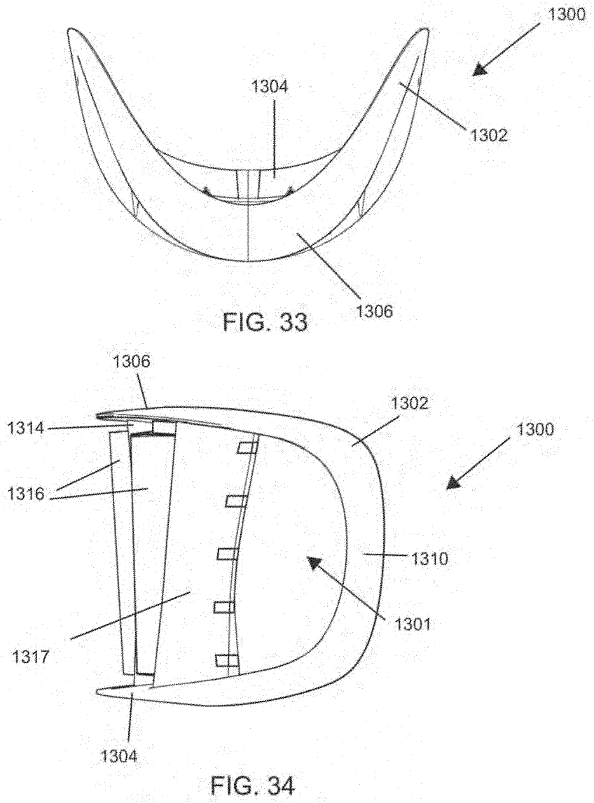

The secondary chamber references above can, for example, be formed by the insert 1300 and a mask because the first and second legs 1304, 1306 of the frame 1302 as shown, for example, in FIG. 34 extend beyond the fins 1316 to create a cavity between the insert 1300 and a mask. The sidewalls 1317 prevent the expelled air from being re-inhaled by a user.

The foregoing description and associated images illustrate several embodiments of the invention and its respective constituent parts. However, other types of materials and patterns combining materials are possible. As such, the images are not intended to be limiting in that regard. Thus, although the description above and accompanying images contain much specificity, the details provided should not be construed as limiting the scope of the embodiments, but merely as providing illustrations of some of embodiments of the present disclosure. The images and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments, including but not limited to the substitutions of equivalent features, materials, or parts, and the reversal of various features thereof, may be practiced by those of ordinary skill in the art without departing from the spirit and scope of the invention.

1. An insert configured to be placed between a face covering and a face of an individual, the insert comprising:
a frame; and
a ventilation mechanism extending directly from the frame and in conjunction with the frame defining a first opening and a second opening through which air is inhaled, the ventilation mechanism comprising a plurality of projections that are spaced from each other, a plurality of fins that are arranged in pairs between the plurality of projections and a first sidewall and a second sidewall, which is spaced from the first sidewall, that delimit the ventilation mechanism of the insert and prevent expelled air from the individual from being re-inhaled,
each fin of the plurality of fins including a living hinge and being independent of and spaced from each other such that in a first state, when the air is being inhaled through the first opening and the second opening, a distal end of each of the fins of each of the pairs of fins extend toward each other and are contactable with each other and in a second state, when the air is exhaled, the distal end of each of the fins flexes and moves away from each other, creating a space between the fins of each of the pairs thereof.

2. The insert apparatus of claim 1, wherein the frame comprises a first curved leg defining a base, a second curved leg, spaced from the first leg, defining a top portion of the insert, a third curved leg, extending between the first and second curved legs, defining a first side of the insert and a fourth curved leg, mirror-opposite the third curved leg, extending between the first and second curved legs, defining a second side of the insert.

3. The insert apparatus of claim 1, wherein the projections extend in a first direction between the fins and in a second direction.

4. The insert apparatus of claim 3, wherein in the second direction, the projections have a triangular shape with the point of the triangle, when the insert is worn by the individual, configured to face a mouth of the individual.

5. (canceled)

6. The insert apparatus of claim 1, wherein the frame and the ventilation mechanism together form a first opening on a first side of the insert and a second opening on a second side of the insert through which air can be inhaled.

7. The insert apparatus of claim 2, wherein the first curved leg and the second curved leg can extend beyond a distal end of each of the fins.

8. The insert apparatus of claim 2, wherein the first curved leg and the second curved leg extend in a same direction configured to contour to a shape of a face of a user.
